(19) United States
(12) Patent Application Publication
(10) Pub. No.: US 2008/0027764 A1
(43) Pub. Date: Jan. 31, 2008

(54) System and method for warranting against leasing losses

(76) Inventors: Adam Marturana, Califon, NJ (US); Mike Stefkovich, Lebanon, NJ (US)

Correspondence Address: Howard IP Law Group, P.O. Box 226, Fort Washington, PA, 19034, US

(21) Appl. No.: 11/906,822

(22) Filed: Oct. 4, 2007

Related U.S. Application Data
(63) Continuation-in-part of application No. 11/414,815, filed on May 1, 2006.

(51) Int. Cl. G06Q 40/00

(52) U.S. Cl. 705/4

(57) ABSTRACT

The method herein provides for the issuance of a warranty contract following an analysis of a lease that may be susceptible to penalties for acts of omission by a lessee. One typical lease requires a notice within a timeframe of the lessee's intent to purchase, renew or return the equipment at the end of the term. If the lessor in the prescribed timeframe does not receive the notice there is an automatic extension or renewal of the lease. Different leasing companies have different notice periods and different “automatic” extensions. The present invention is additionally drawn to a lease expiration or renewal notification and warranty contract system that collects data on one or more lease term risks; analyzes the data associated with the subject matter of the lease, binds and generates a warranty contract and also notifies the lessee and/or lessor regarding the term provision at an appointed date and time.

### RELATED APPLICATION

This application is a continuation-in-part of co-pending-commonly assigned: U.S. patent application Ser. No. 11/414,815 entitled “System and Method for Insuring Against Leasing Losses” filed May 1, 2006, the disclosure of which is hereby incorporated by reference in its entirety.

### FIELD OF THE INVENTION

This invention relates to a method and system for warranting against losses associated with a lease.

### BACKGROUND OF THE INVENTION

Leases generally require a lessee to notify a lessor within a contractual timeframe of its intent to renew, return or purchase the equipment or property at the end of the lease. In the event that a notification is not provided as required under the terms of a lease, an unintended (and often costly) expense may be incurred by the lessee, such as a forced extension or renewal of the lease for a fixed or indefinite timeframe. Lease notice provisions typically provide that a notice of the lessee's intent to purchase, renew or return the equipment must be received by the lessor by, or within, certain dates and specify what the length of the “automatic” renewal will be if the contractual notice is not received by (or sent to) the lessor within the prescribed timeframe.

Different lessors have different lease subject matter such as notice periods and different automatic “evergreen” renewals (contractual extended rental payments due from the lessee) when the notice period is missed by the lessee. For example, vendor leasing companies generally have standard “boiler-plate” documents. Middle-market and large-ticket lessors can have dozens of different agreements. Some leases contain “at least 90 days” or more type written notice language. Additionally, notice periods can have various date ranges, typically from 30 days to 365 days or more. Some notification ranges are in a “window” as for example that the notice must be sent to the lessor “not less than 120 days but not more than 150 days” prior to the lease expiration date. The length of time associated with the automatic renewal periods may be, for example, month-to-month in duration, or may be for a fixed period, typically ranging from about three to twelve months or more. These lease provisions are difficult for lessees to manage, and almost all lessees risk missing this window and hence, risk paying large amounts of evergreen rent.

### SUMMARY OF THE INVENTION

The present invention pertains to a computer system and a method that utilizes a warranty contract to cover all or a portion of the additional contractual rentals payable on a lease due to non-notification by the lessee to the lessor within the prescribed written notice timeframe in the lease documents. In one embodiment, the warranty contracting leaseholder or other interested party would receive a warranty payment that would pay the full face value of the contract, which would range in limits and price, or in an alternative embodiment would make an off-set payment of any additional monthly payments or other fees after the expiration of a lease term. In yet another embodiment, the warranty contracts may be add-ons to existing business insurance or other stand alone financial products.

The present invention also pertains to a method for producing a warranty contract for a leaseholder interest by taking into account subject matter such as at least one lease term risk comprising the steps of: collecting and analyzing data from a leaseholder population; identifying within the leaseholder population a risk having an associated term having the subject matter warranty interest; identifying a warranty contract to countervail the financial effect of risk; applying for warranty contract coverage against the risk associated with the extended term; providing a warranty contract that accounts for the countervailing financial effects of the term risk; and generating or communicating an indicia of the warranty contract.

### BRIEF DESCRIPTION OF THE DRAWINGS

The advantages, nature, and various additional features of the invention will appear more fully upon consideration of the illustrative embodiments now to be described in detail in connection with accompanying drawings wherein:

FIG. 1 is a block diagram illustrating a system for determining the cost associated with warranting based upon experience, quoting, warranty contract generation and binding a warranty contract according to an embodiment of the invention;

FIG. 2 is a flow chart of a method of operation of one embodiment of the invention;

FIG. 3 is a flow chart of a method of operation of one embodiment of the invention;

FIG. 4 is a flow chart of a method of operation of one embodiment of the invention.

FIG. 5 is a flow chart of a method of operation of one embodiment of the invention.

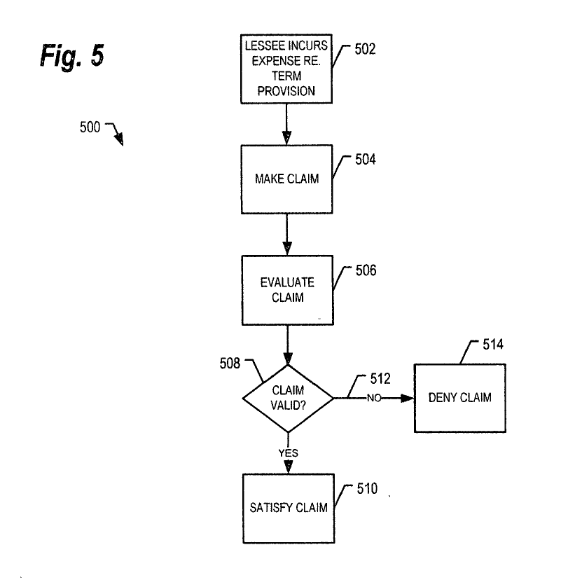

### DETAILED DESCRIPTION OF THE INVENTION

In the figures to be discussed the blocks and arrows represent functions of the process according to embodiments of the present invention which may be implemented as computers, computer executable code, and/or electrical circuits and associated wires or data busses, which transport electrical signals. Alternatively, one or more associated arrows may represent communication (e.g., data flow) between software routines, particularly when the present method or apparatus of the present invention is implemented as a digital process.

In the detailed description that follows, the word warranty shall have the following definitions applied:
(a) To guarantee or attest to the quality, accuracy, or condition of notifying a contracting party of certain obligations, duties, and rights under a lease;
(b) To guarantee a contracting party indemnification against damage or loss resulting from certain obligations, duties, and rights under a lease;
(c) To guarantee the immunity or security of loss resulting from certain obligations, duties, and rights under a lease.

In the event of a breach of warranty, a contracting party to whom the warranty runs is entitled to performance by a warrantor (also referred to as a warranty company). The performance is in the form of an agreed upon monetary sum, which be paid in the in cash or other forms of legally binding promises to pay, or liquidated damages such that the contracting party receives the benefit of its bargain.

To assure compliance with the warranty provisions the warrantor or warranty company may itself purchase a surety bond. In this manner the contracting party is assured compliance with the warranty contract. The warranty contract may include other indemnification rights, duties and obligations including costs for legally defending lessee against losses and costs.

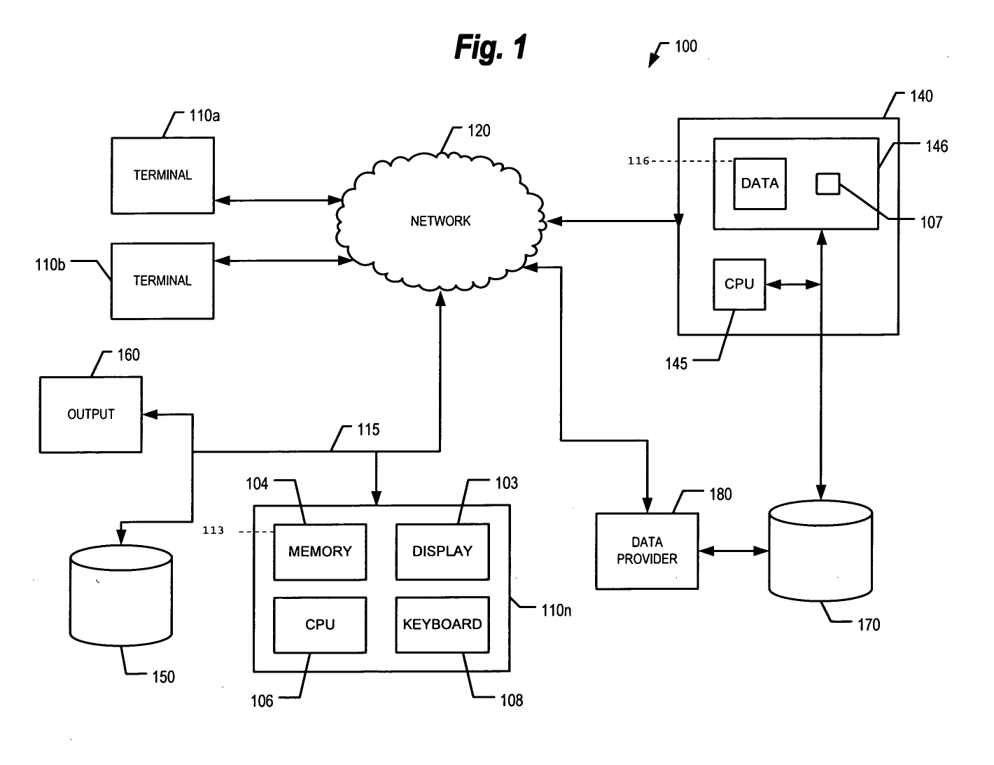

FIG. 1 illustrates an exemplary embodiment of a computing system 100 that may be used for implementing an embodiment of the present invention. Other computing systems may also be used. System 100 generates a warranty contract by: (a) collecting information from a leaseholder population, such as lessees with leases having an associated lease term, to identify lease term risks and determine the cost of a contractual warranty against a default resulting notifying a contracting party of certain obligations, duties, and rights under a lease; (b) creating a warranty to countervail the financial effect of risk exposed to the term risk taking into account the information; (c) receiving lease data revealing the term risk for one or more leases; (d) and supplying the warranty to a leaseholder or other contracting party to countervail the financial effect of risk exposed to the term risk; (e) and to automatically notifying lessees, agents and others involved with servicing a leaseholder population when milestones and other important dates have been reached as specified within a lease.

In one embodiment, system 100 for underwriting, issuing warranty contracts and managing a lease term risk comprises: (a) a computer, such as terminal 110 including a CPU 106 for processing data; (b) one or more data memories including disks such as ones incorporating database 150 for storing data (1) signifying underwriting risks and corresponding cost of the warranty contract or premium rate(s); (2) indicative of the plurality of lessees that have or are likely to purchase a lease risk term warranty; (3) indicative of a plurality of leases, each being associated with a corresponding one of the lessees; and (4) indicative of time-frames, within which written notice regarding termination of each of the leases must be delivered dependently upon the data indicative of the leases. CPU 106 is (1) configured to receive data indicative of the lease terms and compare the lease term data from an applicant for term lease warranty against similar or equivalent lease terms having associated performance risks statistics and corresponding contract costs or premium rates; and (2) configured to prepare a warranty utilizing the underwriting risk statistics and corresponding warranty contract costs or premium rates. The system may also be configured to automatically send, via email or other electronic means, notifications regarding the non renewal of leases.

In general, system 100 includes a network, such as a local area network (LAN) of terminals or workstations, database file servers, input devices (such as keyboards and document scanners) and output devices configured by software (processor executable code), hardware, firmware, and/or combinations thereof, for accumulating, processing, administering and analyzing lease renewal provisions and determining costs associated with the warranty in an automated workflow environment. The system provides for off-line and/or on-line quoting, rating, binding, cost of contract or premium billing, notifying and warranty contract generating. This advantageously results in reduced financial risks of inadvertent lease renewal for policy holders. System 100 additionally provides for electronic data transfer pertaining to actuarial data, warranty contract data and billing relating to avoidable lease renewal losses.

While a LAN is shown in the illustrated system 100, the invention may be implemented in a system of computer units communicatively coupled to one another over various types of networks, such as a wide area networks and the global interconnection of computers and computer networks commonly referred to as the Internet. Such a network may typically include one or more microprocessor based computing devices, such as computer (PC) workstations, as well as servers. “Computer”, as referred to herein, general refers to a general purpose computing device that includes a processor. “Processor”, as used herein, refers generally to a computing device including a Central Processing Unit (CPU), such as a microprocessor. A CPU generally includes an arithmetic logic unit (ALU), which performs arithmetic and logical operations, and a control unit, which extracts instructions (e.g., software, programs or code) from memory and decodes and executes them, calling on the ALU when necessary. “Memory”, as used herein, refers to one or more devices capable of storing data, such as in the form of chips, tapes, disks or drives. Memory may take the form of one or more media drives, random-access memory (RAM), read-only memory (ROM), programmable read-only memory (PROM), erasable programmable read-only memory (EPROM), or electrically erasable programmable read-only memory (EEPROM) chips, by way of further non-limiting example only. Memory may be internal or external to an integrated unit including a processor. Memory may be internal or external to an integrated unit including a computer.

“Server”, as used herein, generally refers to a computer or device communicatively coupled to a network that manages network resources. For example, a file server is a computer and storage device dedicated to storing files, while a database server is a computer system that processes database queries. A server may refer to a discrete computing device, or may refer to the program that is managing resources rather than an entire computer.

Referring still to FIG. 1, system 100 includes one or more terminals 110a, 110b, . . . ,110n. Each terminal 110 has a processor, such as CPU 106, a display 103 and memory 104. Terminals 10 include code operable by the CPU 106 for quoting, determining cost associated with the warranty, rating, binding, billing premiums and generating a lease warranty contract. Terminals 110 also include code operable to create, sell and manage lease warranties, where the issuance of the warranty contract and the receipt of payment of contract costs or premiums based upon the lease warranty contract. A database 150 is interconnected to the terminals 110 for storing predetermined actuarial and rate filings and other data pertinent to a warranty contract generation system. An output device 160, such as a printer or electronic document formatter, such as a portable document format generator, for producing documents, such as hard copy and/or soft copy warranty contract, including at least one of text and graphics, being interconnected and responsive to each of the terminals 110, is also provided. User input device(s) 108 for receiving input into each terminal are also provided.

In one embodiment, output device 160 represents one or more output devices, such as printers, facsimile machines, photocopiers, etc., as for example used to generate hard copy of a warranty contract. Communications lines 115, that may be of wired and/or wireless type, provide interconnectivity between terminals 110, database 150 and one or more networks 120, that may in-turn be communicatively coupled to the Internet, a wide area network, a metropolitan area network, a local area network, a terrestrial broadcast system, a cable network, a satellite network, a wireless network, or a telephone network, as well as portions or combinations of these and other types of networks (all herein referred to variously as a network or the Internet).

In the illustrated embodiment of system 100 other servers 140 having a CPU 145 are in communication with network 120 and terminals 110. As will be recognized by those skilled in the art of networking computers, some or all of the functionality of quoting, determining the cost, rating, binding, billing contract costs or premiums, generating a warranty contract, selling, sending notifications, managing the lease warranty contract, the issuance of the warranty contract and the receipt of payment of premiums may reside on one or more of the terminals 110 or the server 140. Security measures may be used in connection with network transmissions of information, to protect the same from unauthorized access. Such secure networks and methodologies are well known to those skilled in the art of computer and network programming.

In the illustrated embodiment of system 100 server 140 and terminals 110 are communicatively coupled with database 170 to store rate information, information related to lease renewals and other data relating to determining the cost of a warranty contract, creating selling and managing lease renewal warranty contracts based upon the underlying lease provisions. Also available to terminals 110, and stored in databases 150 and 170, are lease data associated with corresponding warranty contracts, actuarial tables and contract costs premiums associated with various types of lease provision coverages. Database connectivity, such as connectivity with database 170, may be provided by a data provider 180.

In one embodiment, terminals 110 and/or the server 140 utilize computer code, such as code 107 operable and embodied in a computer readable medium 146 in server 140 and code operable and embodied in a computer readable medium 104 in terminal 110, respectively, for mitigating financial loss from risks associated with inadvertent lease renewals. The computer code provides for establishing at least one database, such as database 150 and/or database 170, for storing the determining contract losses and corresponding warranty contract costs or premium rates; code for storing data indicative of the plurality of lessees the have or are likely to purchase lease risk term warranty in database 150 and/or database 170; code for storing data indicative of a plurality of leases, each being associated with a corresponding one of the lessees, in database 150 and/or database 170; code for storing data indicative of time-frames, within which written notice regarding termination of each of the leases must be delivered by the lessees dependently upon the data indicative of the leases; code for automatically generating at least one electronic (email, fax, Instant Messaging, etc.) reminder to the lessees or others designated to be notified dependently upon the determined time-frames; code for comparing lease terms from a prospective applicant for term lease warranty contract against similar or equivalent lease terms having associated underwriting risks statistics and corresponding premium rates; and code for utilizing the contract costs for determining warranty risk statistics and corresponding contract costs or premium rates to prepare warranty contracts guaranteeing or warranting the lessees against losses resulting from a failure to deliver written notice regarding termination of each of the leases within the determined time-frames.

In FIG. 1 other hardware configurations may be used in place of, or in combination with software code to implement an embodiment of the invention. For example, the elements illustrated herein may also be implemented as discrete hardware elements. As would be appreciated, terminals 110a, 110b, . . . , 110n and server 140 may be embodied in such means as a general purpose or special purpose computing system, or may be a hardware configuration, such as a dedicated logic circuit, integrated circuit, Programmable Array Logic (PAL), Application Specific Integrated Circuit (ASIC), that provides known outputs in response to known inputs.

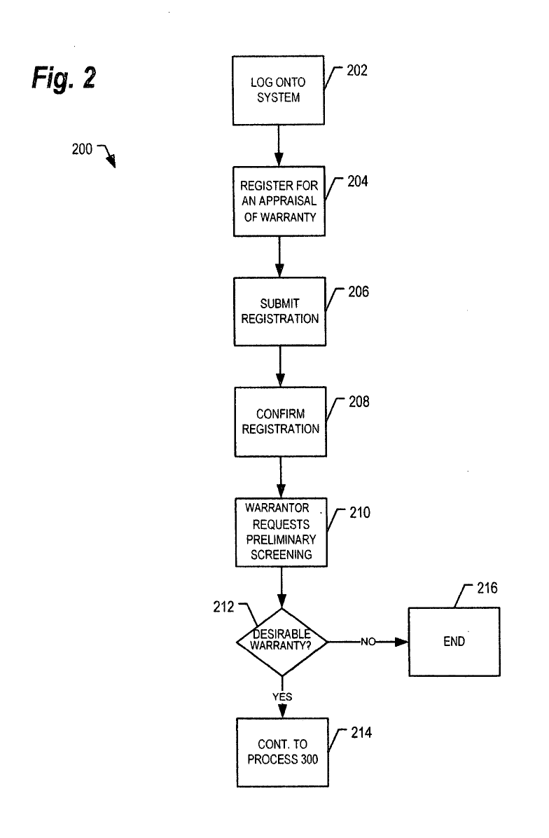

FIG. 2 illustrates the operation of a computer-software implemented process 200 for determining the costs associated with the warranty, quoting, binding, issuing and managing lease renewal warranty contracts according to an embodiment of the present invention. In an embodiment of the invention, process 200 is carried out by a contracting party of a warranty contract dependently upon lease provisions existing within the warranty contract subject matter interest. Software process 200 may be executed using a workstation typical of one or more of the terminals 110, illustrated in FIG. 1. In such an embodiment, system 100 allows users to access process 200 to perform assessment of risks associated costs of warranty contracts; quote warranty coverage and establish warranty contract costs or premiums for lease renewal warranty contracts locally and/or from remote locations relative to a given terminal 110.

Although the following description will refer to a system for generating lease term risk warranty contracts for equipment and building structures, a similar process is applicable to any contracting interest, where the underwriting criteria and the cost or premium are influenced by the provisions of a lease. Such warranty contract subject matter interests include, by way of example only, residential premises, vehicles, marine craft and aircraft.

By way of non-limiting example, lease notice provisions typically have two distinct parts: (1) a prescribed timeframe within which contractual notice must be received by the lessor; and (2) the length of the “automatic” renewal if the lessor does not receive the contractual notice within the prescribed timeframe. Different leasing companies generally have different notice periods and different “automatic” evergreen renewals (extended rents). These are particularly difficult for lessees to manage and result in a high miss rate for the prescribed window and in payments of large amounts of evergreen rent as a consequence. A typical lease may include the following clause, for example:
“This is a non-cancelable lease for the term indicated on the equipment schedule. The term of this Lease shall automatically extend for successive ninety (90) day periods following the end of the initial term unless terminated by Lessee by giving written notice to lessor at least 180 days prior to the end of the initial term, or of any such successive period. Any such termination shall be effective only on the last day of the initial term or the last day of such successive period.”

Such an automatic renewal (evergreen rent) takes effect when the lessee fails to provide notification within the prescribed time frame (misses the notice period) and results in an automatic lease extension (e.g., 90 day extension). According to an embodiment of the invention, the exact notice “window” for a lease in the system, is determining regardless of who the lessor is or what type of leasing document is employed. Additionally, a process implementing system automatically notifies the lessee at pre-determined intervals prior to the contractual notice period to facilitate compliance with the written notice provisions in the lease agreement.

Referring still to FIGS. 1 and 2, a first block 202 utilizes input device 108 to facilitate a warranty contracting party agent logging into process 200 through a terminal 110 having a display 103, and that connects to database 150 and network 120. Utilizing the input device 108 in a next block 204, the lessee enters information pertaining to its interest as an indemnified party for whom term risk lease warranty contracts dependent upon the lease provisions is to be underwritten is entered. Such information, by way of example and not limitation, may include: the name, address, telephone number of the lessee or indemnified party, the date the request for the quotation, and a description of the contracting party, potential or actual leaseholder lessee operation and the standard industrial codes (“SIC”) associated with the business. At block 206, the registration information is submitted, a confirmation is received from the warranty contractor company at block 208. The warrantor or warranty company requests preliminary information at block 210 and screens out applications that request coverage on interests that the warranty company deems unwarrantable or undesirable at block 212. If the request relates to an undesirable interest, process 200 ends at block 216. If the potential or actual leaseholder results in a potential prospect for determining the cost associated with offering and warranting various lease conditions, then process 200 proceeds to process 300 at block 214.

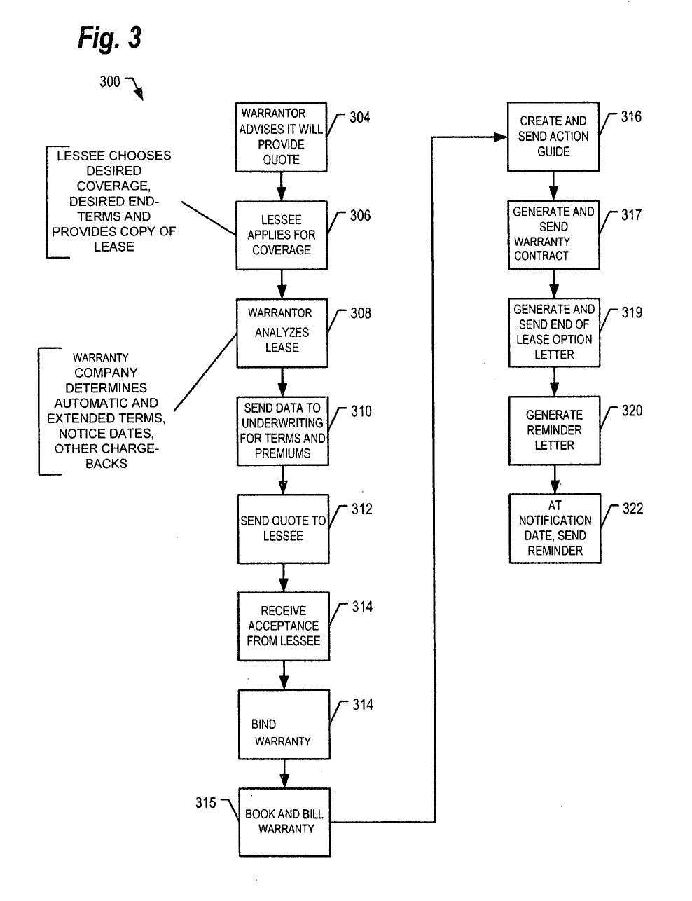

By way of further example and not limitation, the lessee may apply to purchase an individual lease warranty contract or a blanket policy for multiple leases based on individual and business requirements. Referring now to FIG. 3, there is shown a block diagram of a process 300 that provides for warranting against the inadvertent missed termination or a renewal notice by the lessee to the lessor according to an embodiment of the invention. The lessee and the warrantor or warranty company were previously engaged in the process 200 preliminary stages of registering or applying for the purchase of a warranty contract where the screening is performed. At block 304, the warrantor or warranty company notifies the prospective customer lessee that it will provide a quotation and provides the prospective customer with a list of information to provide to receive the quote for warranty coverage. At block 306, the lessee responds by choosing the desired coverage, end terms and corresponding notices (e.g., up to three (3) end of term notices) to be sent to it by the warranty company prior to, dependent upon, e.g., the contractual notice period date in the lease agreement. The lessee, dealer, warranty company, accountant or other third party agent of the lessee also sends the lease and equipment schedule to the warranty company via the Internet, facsimile or mail, for example, at block 306.

The warranty company ascertains and analyzes the information from the lease and equipment schedule and determines when the lessee must deliver written notice to the lessor, prior to the end of the lease, and the consequential automatic extended terms (evergreen renewal) if the contractual notice are not sent to the lessor per the terms of the lease at block 308. As indicated above, lessors have varying “automatic” evergreen renewals, which the process 300 identifies as ranging from days to more than one year. The warranty company also utilizes system 100 to analyze the lease for any payment bill backs or penalties as suggested by the foregoing example, by the lessor and other contingencies the might exist at end of the lease term.

By way of further, non-limiting example only, an end of lease provision may read:
“End of Lease: Lessee may purchase, renew or return all of the equipment subject to the terms and conditions of the lease. Lessee must provide to Lessor written notice of its intent to purchase, renew or return the equipment by certified mail at least 60 days prior to the expiration of initial lease term (or any renewal term). If Lessee fails to notify Lessor as provided herein, this lease will be extended on a month to month basis, until Lessee has given at least 60 days written notice of its intention to purchase, renew or return the Equipment. Such notice will be effective only upon completion of all of Lessee's obligations under the lease. Lessee agrees that lease payments received after the initial lease term are payments for the use of the equipment and shall not be applied to the end of lease purchase option.”

The warranty company accesses through terminal 110 data required to compare lease terms from the prospective applicant for term lease warranty against similar or equivalent lease terms having associated risk statistics and corresponding contract costs or premium rates. It then submits the parameters from the lease terms from the prospective applicant to a module operating to calculate the corresponding premium rates in preparation of a warranty contract for warranting the lessees against losses resulting from a failure to deliver written notice regarding termination of each of the leases within the determined time-frames. Essentially, the foregoing cost of the warranty contract is determined at block 310, by actuarial analysis identifying a term risk within the leaseholder population of leases and creating a warranty contract to countervail the financial effect of the risk.

In one embodiment, the financial effect of the risk is determined using the monthly lease payment multiplied by the anticipated contractual evergreen rent that would accrue from non-notification. By way of further example, and not limitation, the cost of the warranty contract may be based on the monthly lease payment multiplied by the anticipated contractual renewal rents that would accrue if the notice period is missed, multiplied by a fixed percentage to determine the cost of the policy. The determination of a fixed percentage may be ascertained from collecting data from a leaseholder population stored in database 150 or 170 that indicates experienced lease term losses or provides through comparison or analysis other established actuarial methods well known by those skilled in the art of underwriting the warranty. By way of further example, and not limitation, the warranty contract cost or premiums may be calculated using system 100 as follows:
1. For a $10,000 computer system having a 36 month lease and a $300 monthly payment. If the lease has an automatic six month renewal if the notice period is missed, the contract cost would be calculated as: $300×6=$1800 (Amount of anticipated renewals) $1800×7.5%=$135.
2. For a $5,000,000 printing press having a 60 month term and a $80,000 monthly payment. If the lease has 90 day notice period with three months of renewals if the notice period is missed, the contract cost would be calculated as: $80,000×3=$240,000 (Amount of anticipated renewals) and $240,000×3%=$7,200.00.

Referring again to FIG. 3, process 300 sends the quotation and offer to bind the warranty contract to the lessee at block 312. In one embodiment, this includes creating a letter, e.g., a quote letter, using a word processing program with an option to select various contract costs or premiums calculated from rating process block 310.

Upon receipt of the quotation letter, the lessee decides to accept or reject the offer at block 313. If accepted, the warranty company proceeds to bind the warranty contract coverage at block 314. In an embodiment, the binding process includes creating a letter, e.g., a binder letter, using a word processing program with an option to select a premium option calculated from rating process block 310. Booking and billing then occurs at block 315. According to an embodiment, booking and billing includes selecting industry code, ISO class, a payment plan and billing method.

Additionally, the warranty company, at block 316, creates and sends the lessee an action guide, detailing lease provisions to help avoid any lessor bill backs at end of term. At block 317, the warranty company issues a policy, which includes printing and issuing the warranty contract in an embodiment of the present invention. The warranty company then generates a pre-dated end of lease option letter to the lessee at the first lessee chosen date per the policy, at block 319. This letter details the lessee's end of term options. The warranty company then generates one or more reminder notifications per the predetermined dates on the policy, at block 320. The lessee is thus automatically reminded to send the end of term notifications at block 322 with a copy to the warranty company, thereby ensuring timely compliance with the terms of the lease schedule.

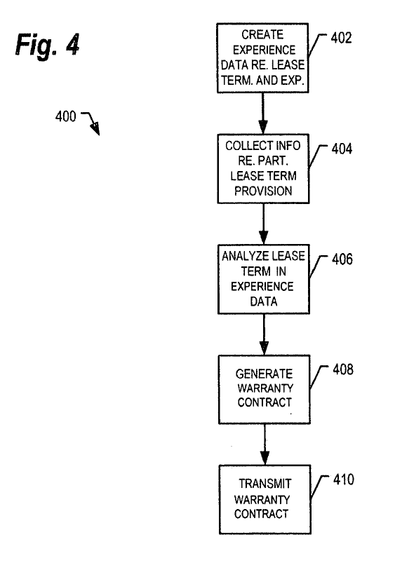

Referring now also to FIG. 4, there is shown a process 400. According to an embodiment of the invention, process 400 is also executed by computer system 100. Process 400 relates to generating a warranty contract by: (a) creating warranty experience data at block 402, based upon information from a known leaseholder population. The leaseholder population includes statistics on losses associated with lease term extensions and renewals as well as frequency of occurrence under varying circumstances including but not limited to industry, class of equipment or properties and other factors considered pertinent to the determination of risk and associated premiums. According to an embodiment of the invention, factors considered pertinent to the determination of risk and associated contract warranty costs or premiums are collected from a leaseholder population having experienced a term risk loss associated with an event affecting lease expiration or extension to create actuarial data. When a new warranty contract application is made, the warranty company analyzes one or more term risk results associated with the warranty lease interest at block 404. If the analysis reflects that the warrantee interest being applied for is exposed to at least one term risk, then the warranty company determines the premium based upon the actuarial results. The warranty company essentially analyzes the results associated with the actuarial data and associated with the term risk event and the indemnified interest, at block 406. Following determining the cost of warranty based upon experience and other factors, the warranty contractor company generates a warranty contract for the warranty interest, at block 408, and transmits a copy of the indicia of warranty to the lessee or other interested party, at block 410. The terminal 110 may be used to store the policy in memory integral to the terminal and/or it may print the policy. Alternatively, data regarding the policy may be stored elsewhere on the network.

If a lessee obtains a warranty contract, such as in accordance with the foregoing processes, and a related breach is incurred, claim process 500 may proceed. At block 502, a cost or expense is incurred due to having either an inadvertent extension or renewal of a lease term. The lessee makes a claim under the warranty contract at block 504. Such a claim would cause the warranty contractor company to take the additional step of evaluating the claim under the warranty contract at block 506. If the claim proves valid at block 508, then the claim is satisfied at block 510. If the claim proved invalid, at line 512, the claim is denied at block 514.

While the foregoing invention has been described with reference to the above embodiments, additional modifications and changes can be made without departing from the spirit of the invention. Accordingly, such modifications and changes are considered to be within the scope of the appended claims.

What is claimed is:

1. A method for mitigating risk associated with inadvertent lease renewals or extensions and a plurality of lessees, comprising:
providing at least one database;
storing data indicative of the plurality of lessees in the at least one database;
storing data indicative of a plurality of leases, each being associated with a corresponding one of the lessees, in the at least one database;
storing data indicative of time-frames within which written notice regarding termination of each of the leases must be delivered by the lessees to avoid inadvertent lease renewals or extensions, dependently upon the data indicative of the leases;
warranting the lessees against losses resulting from a failure to deliver written notice regarding termination of each of the corresponding leases within the determined time-frames; and,
automatically generating reminders to the lessees dependently upon the determined time-frames.

2. The method of claim 1, wherein the warranty loss includes costs associated with at least one of a lease extension and a lease renewal.

3. The method of claim 2, further comprising screening potential lessees to determine if they qualify for the warranty contract.

4. The method of claim 3, wherein the warranting comprises offering warranty contracts to the lessees.

5. The method of claim 4, wherein the warranty contract includes costs for legally defending lessee against losses and costs.

6. The method of claim 5, further comprising storing data indicative of the warranting in the at least one database.

7. The method of claim 6, further comprising receiving a claim relating to the warranting.

8. The method of claim 7, further comprising evaluating the claim dependently upon the stored data indicative of the warranting.

9. The method of claim 8, further comprising satisfying the warranty claim.

10. The method of claim 8, further comprising denying the warranty claim.

11. The method of claim 1, wherein the warranting comprises:
collecting and analyzing data from a leaseholder population;
identifying an associated lease term risk and a corresponding warranty subject matter;
providing a warranty contract that accounts for the data and the countervailing financial effects of the term risk; and,
generating a warranty contract.

12. The method of claim 1, wherein warranting further comprises:
collecting information from lessees with leases having an associated lease term to determine the cost of providing a warranty contract to warranty against lease term risks;
creating a warranty contract to countervail the financial effect of risk exposed to the term risk taking into account the information; and,
supplying the warranty contract to a lessee to countervail the financial effect of risk exposed to the term risk.

13. The method of claim 1, wherein the warranting further includes purchasing a surety bond.

14. A computer program product being embodied in a computer readable medium for mitigating risk associated with inadvertent lease renewals and a plurality of lessees, the computer program product comprising:
code for providing at least one database;
code for storing data indicative of the plurality of lessees in the at least one database;
code for storing data indicative of a plurality of leases, each being associated with a corresponding one of the lessees, in the at least one database;
code for storing data indicative of time-frames within which written notice regarding termination of each of the leases must be delivered by the lessees dependently upon the data indicative of the leases;
code for automatically generating at least one reminder to the lessees dependently upon the determined time-frames; and,
code for preparing warranty contract warranting the lessees for losses resulting from a failure to deliver written notice regarding termination of each of the leases within the determined time-frames.

15. A computer system for mitigating risk associated with inadvertent lease renewals and a plurality of lessees, comprising:
means for storing data indicative of the plurality of lessees in the at least one database;
means for storing data indicative of a plurality of leases, each being associated with a corresponding one of the lessees, in the at least one database;
means for storing data indicative of time-frames within which written notice regarding termination of each of the leases must be delivered by the lessees dependently upon the data indicative of the leases;
means for automatically generating at least one reminder to the lessees dependently upon the determined time-frames; and,
means for preparing warranty contract warranting the lessees for losses resulting from a failure to deliver written notice regarding termination of each of the leases within the determined time-frames

16. The computer system of claim 15, further comprising:
means for qualifying an applicant for lease warranty contract;
means for generating a statistic indicative of a term risk;
means for making a calculation that associates the occurrence of the term risk to a pay out to countervail the associated term risks and a premium; and,
means for generating a warranty contract for the term risk and means to communicate an indicia of the warranty contract to a lessee.

17. A data processing system for underwriting, issuing and managing a lease risk term warranty contract comprising:
computer including a CPU for processing data; and, one or more memories for storing data: (1) signifying costs of providing warranty contracts based upon experience and corresponding cost of contract rates; (2) indicative of the plurality of lessees that have or are likely to purchase lease risk term lease warranty contract; (3) indicative of a plurality of leases, each being associated with a corresponding one of the lessees; and (4) indicative of time-frames, within which written notice regarding termination of each of the leases must be delivered dependently upon the data indicative of the leases; wherein said CPU is:
configured to compare lease terms from a prospective applicant for term lease warranty contract against similar or equivalent lease terms having associated risk statistics and corresponding premium rates;
configured to prepare a warranty contract utilizing the risk statistics and corresponding premium rates; and,
configured to prepare and send notices of non renewal of one or more leases within the indicated of time-frames.
